(19) United States
(12) Patent Application Publication
(10) Pub. No.: US 2008/0088693 A1
(43) Pub. Date: Apr. 17, 2008

(54) Content transmission method and apparatus using video call

(75) Inventors: Kyoung-je Oh, Suwon-si (KR); Hee-young Lee, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/700,075

(22) Filed: Jan. 31, 2007

(30) Foreign Application Priority Data
Oct. 17, 2006 (KR) 10-2006-0101032

(51) Int. Cl. H04N 7/14

(52) U.S. Cl. 348/14.01

(57) ABSTRACT

A content transmission method and apparatus using video call is provided. The content transmission method includes performing an encoding operation on reproduced content; and transmitting the encoded content to at least one of video call apparatuses connected to a network, wherein the content is distinguished from video and the voice data. The content is reproduced by the content transmission apparatus or an external content providing server. Therefore, the content transmission apparatus can share content with another type of apparatus that supports VoIP, such as a digital signage.

### CROSS-REFERENCE TO RELATED PATENT APPLICATION

This application claims the priority from Korean Patent Application No. 10-2006-0101032, filed on Oct. 17, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to sharing content with a plurality of video call apparatuses connected to a network, and more particularly, to transmitting content as well as video signals and voice signals in a voice over Internet protocol (VoIP)-based video call apparatus.

2. Description of the Related Art

Today, people around the world can freely communicate with each other through the Internet, and various industry groups are linked with the Internet. Even before the introduction of the Internet, it was possible to communicate with people not only in Korea but also anywhere in the world at home. A telephone was invented in 1976 by an American named Graham Bell. However, the call quality of the telephone invented by Graham Bell was so poor that it had no practical use. It was when Edison invented a carbon microphone and a transistor for amplifying sound that a prototype of today's telephone was completed.

Recently, a technology known as a VoIP technology has been used. The VoIP technology converts voice data into an Internet data packet and thus makes voice communication in a computer network possible as in a traditional telephone network. The VoIP technology, also known as an Internet phone, was initiated when Vocaltec attempted to make voice communications over the Internet in 1995. The Internet phone at its early stage used the same software between computers to provide a communication service. However, the Internet phone of today has gone through uninterrupted development and achieved quality enhancement. In addition, since the Internet phone of today is used in the form of phone to phone instead of personal computer (PC) to PC, there has been a significant improvement of user convenience. The VoIP technology enables a voice service, which has so far been provided in a public switched telephone network (PSTN), to be provided using an Internet protocol. Furthermore, various voice services, which could not be provided in the traditional telephone network, can be provided using the VoIP technology.

If various application programs of VoIP phones are developed, people will soon be able to make phone calls as well as exchange messages, thereby having a more effective communication. For example, it may be possible to call a restaurant and make a reservation while viewing a menu which is transmitted from the restaurant and displayed on a screen of a VoIP phone. VoIP phones may also be used to make an announcement or manage attendance in companies. Since VoIP phones can be used in various forms, the scope of application programs of the VoIP phones is unlimited. When it comes to VoIP phones, distance is meaningless. Therefore, VoIP phone call rates are inexpensive, and calls between Internet phones are even free. VoIP phones can also provide integrated voice/data/video services. Such features of VoIP phones are attractive enough to draw users.

However, related art video call apparatuses, such as VoIP phones, are designed to simply transmit video and voice signals, but do not have a function for sharing content. Video call apparatuses having the content sharing function are very expensive and require protocol compatibility and a complicated connection process. In addition, video call apparatuses at both server and client ends require dedicated programs for executing content.

### SUMMARY OF THE INVENTION

The present invention provides a method and apparatus for sharing content with a video call apparatus which does not support a content sharing protocol.

According to an aspect of the present invention, there is provided a content transmission apparatus which transmits content to a plurality of video call apparatuses which perform an encoding operation and a corresponding decoding operation on video data and voice data and transmit or receive the encoded and decoded video data and voice data. The content transmission apparatus includes a signal processing unit which performs the encoding operation on reproduced content; and a network connection unit which transmits the encoded content to at least one of the video call apparatuses connected to a network, wherein the content is distinguished from the video data and the voice data.

The content transmission apparatus may further include a remote access unit which accesses an external content providing server and receives content.

The video call apparatus may support VoIP and may be a digital signage.

The content may be reproduced by the content transmission apparatus or the external content providing server. If the content is reproduced by the external content providing server, the reproduced content by the external content providing server may be transmitted to the content transmission apparatus.

The video call apparatus may decode the encoded content and display the decoded content.

According to another aspect of the present invention, there is provided a content transmission method used by a content transmission apparatus which transmits content to a plurality of video call apparatuses which perform an encoding operation and a corresponding decoding operation on video data and voice data and transmit or receive the encoded and decoded video data and voice data. The content transmission method includes performing the encoding operation on reproduced content; and transmitting the encoded content to at least one of the video call apparatuses connected to a network, wherein the content is distinguished from the video data and the voice data.

The content may be reproduced by the content transmission apparatus or an external content providing server. If the content is reproduced by the external content providing server, the reproduced content by the external content providing server may be transmitted to the content transmission apparatus.

The method may further include decoding the encoded content and displaying the decoded content using the video call apparatus.

According to another aspect of the present invention, there is provided a computer readable recording medium storing a computer program for performing the content transmission method.

### BRIEF DESCRIPTION OF THE DRAWINGS

The above and other aspects of the present invention will become more apparent by describing in detail exemplary embodiments thereof with reference to the attached drawings in which:

FIG. 1 is a schematic block diagram of a video call system according to an exemplary embodiment of the present invention;

FIG. 2 is a block diagram of a video call apparatus at a transmitting end according to an exemplary embodiment of the present invention;

FIG. 3 is a flowchart illustrating a content transmission method according to an exemplary embodiment of the present invention; and

FIG. 4 is a flowchart illustrating a content transmission method according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth therein, rather, these exemplary embodiments are provided so that this disclosure will be thorough and complete, and will fully convey the concept of the invention to those skilled in the art.

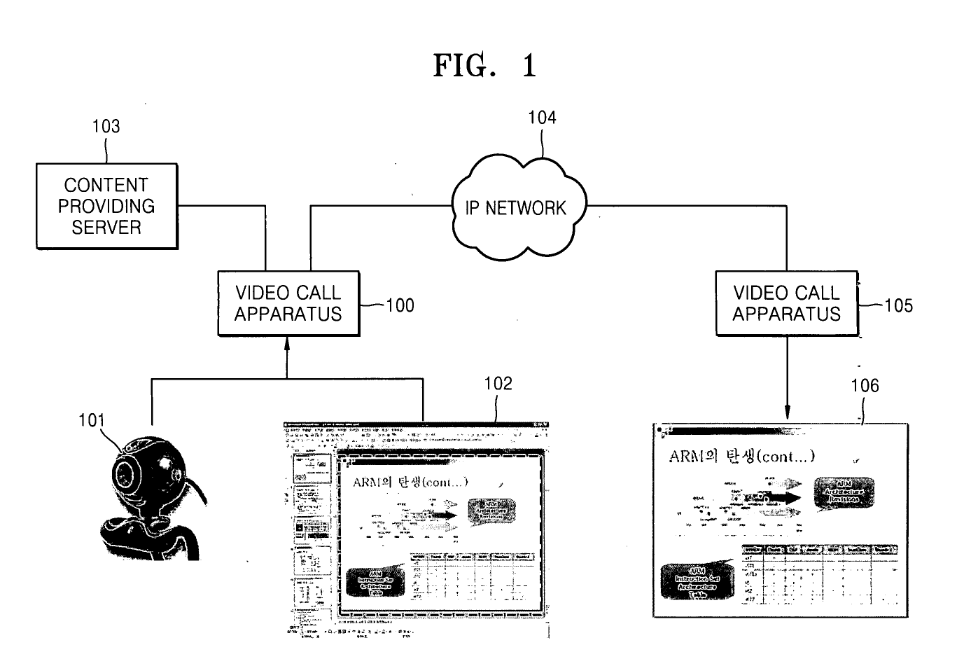

FIG. 1 is a schematic block diagram of a video call system according to an exemplary embodiment of the present invention. The video call system includes a video call apparatus 100 at a transmitting end, a camera 101, a display unit 102 of the video call apparatus 100 at the transmitting end, a content providing server 103, an Internet protocol (IP) network 104, a video call apparatus 105 at a receiving end, and a display unit 106 of the video call apparatus 105 at the receiving end.

Referring to FIG. 1, a video/voice signal input from the camera 101 or a microphone (not shown) is subjected to signal processing, such as encoding, in the video call apparatus 100 at the transmitting end. Then, the processed signal is displayed on the display unit 106 at the receiving end through the IP network 104.

The video call apparatus 100 at the transmitting end remotely accesses the external content providing server 103 and reproduces content. Thereafter, the video call apparatus 100 captures a portion of a video memory region storing an Excel file as shown on the display unit 102, which is the result of reproduction or reproduced by the video call apparatus 100, encodes the portion, and stores the encoded portion in a video memory. The encoded content is displayed on the display unit 106 of the video call apparatus 105 at the receiving end through the IP network 104.

In other words, the video call apparatus 100 at the transmitting end according to the present exemplary embodiment is a content transmission apparatus. The video call apparatus 100 at the transmitting end processes a video/voice signal and transmits the processed signal to the video call apparatus 105 at the receiving end. In addition, the video call apparatus 100 captures a portion of the video memory region storing content reproduced by the content providing server 103 or reproduced by the video call apparatus 100, performs signal processing on the captured portion, and transmits the result of signal processing to the video call apparatus 105 at the receiving end.

In another exemplary embodiment, the video call apparatus 100 at the transmitting end may reproduce a picture file, such as a JPEG file, in addition to the Excel file or reproduce the picture file using the external content providing server 103. Then, the video call apparatus 100 may encode the reproduced picture file and transmit the encoded picture file to the video call apparatus 105 at the receiving end.

The video call apparatus 105 at the receiving end performs basic functions of a conventional video call apparatus. In other words, the video call apparatus 105 encodes/decodes a video/voice signal and outputs the encoded/decoded video/voice signal. The video call apparatus 105 at the receiving end is an inexpensive video call apparatus which does not support a content sharing protocol. Hereinafter, the video call apparatus 105 at the receiving end will be understood as an apparatus which supports VoIP but does not support the content sharing protocol. Examples of the video call apparatus 105 may include a conventional video call apparatus, a digital signage, a computer, a refrigerator, and a television.

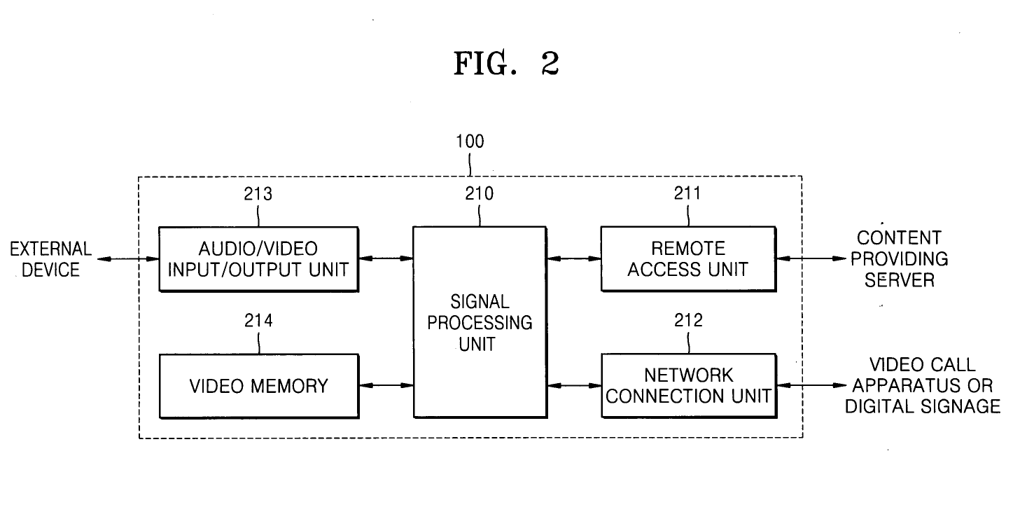

FIG. 2 is a block diagram of a video call apparatus 100 at a transmitting end according to an exemplary embodiment of the present invention. Referring to FIG. 2, the video call apparatus 100 includes a signal processing unit 210, a remote access unit 211, a network connection unit 212, an audio/video input/output unit 213, and a video memory 214.

An external device may be any one of a microphone, a camera, a display, and a speaker.

The signal processing unit 210 receives a voice/video signal from the external device, performs signal processing, such as encoding, on the received voice/video signal, and transmits the processed voice/video signal to the video call apparatus 105 at the receiving end through the network connection unit 212. Furthermore, the video call apparatus 100 captures a portion of a video memory region storing reproduced content and encodes the captured portion. Then, the video call apparatus 100 stores the encoded portion in the video memory 214 or transmits the encoded portion to the video call apparatus 105 at the receiving end through the network connection unit 212.

The remote access unit 211 accesses the content providing server 103 and fetches desired content from the content providing server 103 or executes the desired content on the content providing server 103 and displays the result of the executed content. In other words, by using the remote access unit 211, the video call apparatus 100 at the transmitting end can be a thin client. Therefore, the video call apparatus 100, which is a client, accesses the external content providing server 103 whenever it needs content requiring programs such as Excel, Word, and Photoshop. Then, the video call apparatus 100 at the transmitting end executes the content on the content providing server 103 instead of downloading the content, receives the result of the content execution, and displays the received result. Since the video call apparatus 100, which has resources insufficient to reproduce content, includes the remote access unit 111, it can remotely receive content and transmit the content displayed on its screen to the video call apparatus 105 at the receiving end.

The audio/video input/output unit 213 functions as an interface between the external device, i.e., a microphone, a camera, a display or a speaker, and the signal processing unit 210. In other words, the audio/video input/output unit 213 has a function of a conventional video call apparatus.

The video memory 214 stores content captured by the signal processing unit 210.

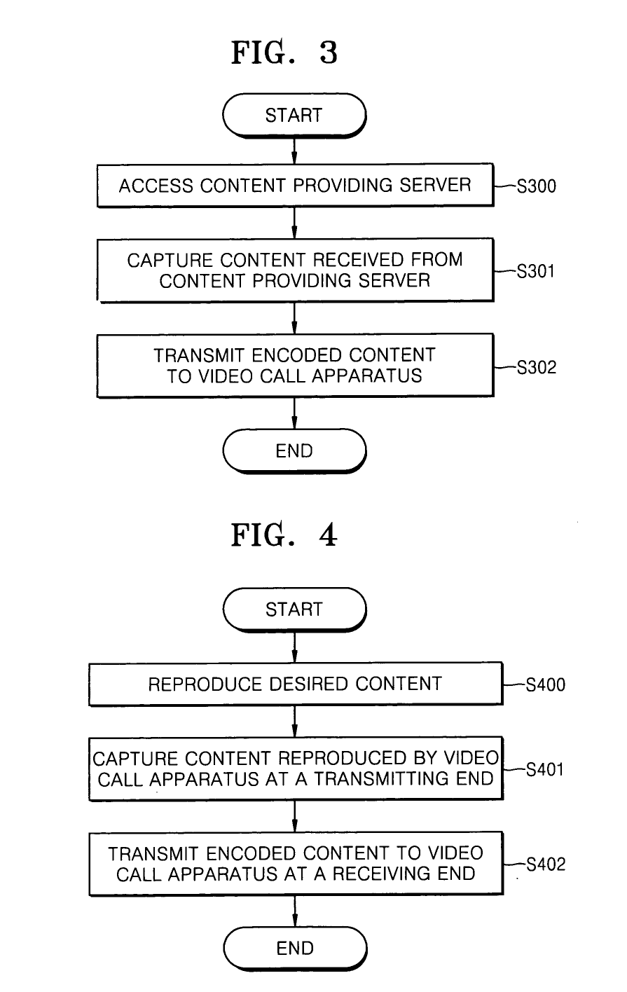

FIG. 3 is a flowchart illustrating a content transmission method according to an exemplary embodiment of the present invention. In the present exemplary embodiment, it is assumed that the video call apparatus 100 at the transmitting end functions as a thin client.

Referring to FIG. 3, a user communicates with the video call apparatus 100, which supports a VoIP function, through the network connection unit 212. Here, the user uses an external device, such as a microphone, a camera, a display and a speaker, to communicate with the video call apparatus 100 through the audio/video input/output unit 213. While the user communicates with the video call apparatus 100, if it is required to transmit content, such as the Excel screen on the display unit 102 illustrated in FIG. 1, the video call apparatus 100 at the transmitting end accesses the content providing server 103 through the remote access unit 211 in operation 300.

In operation 301, the content providing server 103 reproduces the content, and the result of the reproduced content is displayed on the display unit 102 of the video call apparatus 100 at the transmitting end. Then, the video call apparatus 100 captures a portion of a video memory region storing the reproduced content, encodes the captured portion, and transmits the encoded portion to the video call apparatus 105 at the receiving end in operation 302.

FIG. 4 is a flowchart illustrating a content transmission method according to another exemplary embodiment of the present invention. In the present exemplary embodiment, it is assumed that an application for reproducing content is included in the video call apparatus 100 at the transmitting end. As in the content transmission method illustrated in FIG. 3, while a user communicates with the video call apparatus 100, if it is required to transmit content, such as the Excel screen on the display unit 102 illustrated in FIG. 1, the video call apparatus 100 at the transmitting end reproduces and displays the content in operation 400.

In operation 401, the video call apparatus 100 captures a portion of a video memory region storing the reproduced content in order to transmit the displayed content.

In operation 402, the video call apparatus 100 at the transmitting end performs signal processing, such as encoding, on the captured portion and transmits the encoded portion to the video call apparatus 105 at the receiving end.

As described above, a content transmission apparatus according to the exemplary embodiments of the present invention transmits content using VoIP Internet telephony. Therefore, the content transmission apparatus can share content with another type of apparatus that supports VoIP, such as a digital signage.

In addition, since the content transmission apparatus has a remote access function, it can reduce the amount of resources required of a video call apparatus at a receiving end to reproduce content.

Even if all video call apparatuses do not support a content sharing protocol, they can receive content from another video call apparatus and display the received content.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A content transmission apparatus which transmits content to a plurality of video call apparatuses which perform an encoding operation and a corresponding decoding operation on video data and voice data and transmit or receive the encoded and decoded video data and voice data, the content transmission apparatus comprising:
a signal processing unit which performs the encoding operation on reproduced content; and
a network connection unit which transmits the encoded content to at least one of the video call apparatuses connected to a network,
wherein the content is distinguished from the video data and the voice data.

2. The content transmission apparatus of claim 1, further comprising a remote access unit which accesses an external content providing server and receives content.

3. The content transmission apparatus of claim 1, wherein the video call apparatus supports a voice over Internet protocol (VoIP).

4. The content transmission apparatus of claim 3, wherein the video call apparatus is a digital signage.

5. The content transmission apparatus of claim 2, wherein the content is reproduced by the content transmission apparatus or the external content providing server.

6. The content transmission apparatus of claim 5, wherein, if the content is reproduced by the external content providing server, the reproduced content by the external content providing server is transmitted to the content transmission apparatus.

7. The content transmission apparatus of claim 3, wherein the video call apparatus decodes the encoded content and displays the decoded content.

8. A content transmission method used by a content transmission apparatus which transmits content to a plurality of video call apparatuses which perform an encoding operation and a corresponding decoding operation on video data and voice data and transmit or receive the encoded and decoded video data and voice data, the method comprising:
performing the encoding operation on reproduced content; and
transmitting the encoded content to at least one of the video call apparatuses connected to a network,
wherein the content is distinguished from the video data and the voice data.

9. The method of claim 8, wherein the content is reproduced by the content transmission apparatus or an external content providing server.

10. The method of claim 9, wherein, if the content is reproduced by the external content providing server, the reproduced content by the external content providing server is transmitted to the content transmission apparatus.

11. The method of claim 8, further comprising decoding the encoded content and displaying the decoded content using the video call apparatus.

12. A computer readable recording medium storing a computer program for performing a content transmission method used by a content transmission apparatus which transmits content to a plurality of video call apparatuses which perform an encoding operation and a corresponding decoding operation on video data and voice data and transmit or receive the encoded and decoded video data and voice data, the method comprising:
performing the encoding operation on reproduced content; and
transmitting the encoded content to at least one of the video call apparatuses connected to a network,
wherein the content is distinguished from the video data and the voice data.
